(19) United States
(12) Patent Application Publication
(10) Pub. No.: US 2016/0292477 A1
(43) Pub. Date: Oct. 6, 2016

(54) AIMER FOR BARCODE SCANNING

(71) Applicant: Hand Held Products, Inc., Fort Mill, SC (US)

(72) Inventor: Dean Jeffrey Bidwell, Renton, WA (US)

(21) Appl. No.: 14/674,329

(22) Filed: Mar. 31, 2015

(51) Int. Cl. G06K 7/10; H04M 1/02

(52) U.S. Cl. CPC G06K 7/10732; H04M 1/0202; H04M 1/0264; G06K 7/10821

(57) ABSTRACT

When imaging with a smartphone, a user typically uses the smartphone's display as a viewfinder. The user aligns the smartphone's camera with a target by focusing on the display rather than the target. Traditionally, barcode scanners have used aimers rather than viewfinders for this alignment. An aimer projects a visible pattern onto a target. To scan a barcode, a user aligns and positions this visible pattern with the barcode. This approach to barcode targeting is highly desirable for regular barcode scanning. The present invention embraces an aimer for a smartphone that allows a user to target a barcode with a projected pattern, while using the smartphone's imaging-system and processing to scan the barcode. In some embodiments, the aimer is incorporated in a case for the smartphone.

### FIELD OF THE INVENTION

The present invention relates to barcode scanning and, more specifically, to an aimer for facilitating the alignment of a camera for barcode scanning.

### BACKGROUND

Mobile computing devices, such as smartphones, may be configured by software applications to scan barcodes. These applications may configure a smartphone's integrated camera to capture an image of a barcode, process the captured image, and recognize and decode the barcode. Historically, imaging with a smartphone has been relatively slow due to autofocusing and high-resolution image processing. This lack of speed has limited the usefulness of a smartphone as a barcode scanner, especially when routine barcode scanning is required.

Routine barcode scanning with a smartphone is also limited by the awkwardness associated with targeting a barcode. Since the smartphone's display must be used as a viewfinder, the user must focus on the smartphone's screen and not on the barcode. This approach may be difficult if the image on the screen is unfocused/underexposed (i.e., dark) or if the smartphone must be oriented with the screen turned away from the user (e.g., scanning barcodes in tight areas).

Imaging with a smartphone's built-in camera has improved in recent years. Today's smartphone cameras allow for faster and more reliable focusing. The processing power in smartphones has improved and can better handle high-resolution imaging. As a result, smartphones are now more viable for barcode scanning, but they are still limited by the awkwardness associated with aiming.

Barcode scanners designed for routine scanning (i.e., professional or enterprise-grade scanners) typically utilize an aimer. The aimer uses a projector to cast a visible pattern onto a barcoded item. The user aligns the projected pattern with the barcode to insure proper scanning. An aimer integrated with a smartphone would allow the smartphone to operate much like an enterprise-grade scanner and would be highly desirable to users seeking versatile and cost efficient barcode scanners.

Therefore, a need exists for an aimer integrated with a smartphone to allow the smartphone to target barcodes easily, quickly, and accurately.

### SUMMARY

Accordingly, in one aspect, the present invention embraces an aimer to facilitate barcode scanning using a smartphone with a camera. The aimer includes a light source module, a projection module, an electronic module, and a housing. The light source module is used to create a light beam when it is activated. The projection module is used to form the light beam into a pattern and to steer and project the pattern into an area aligned with the field of view of the smartphone's camera. The electronic module is electrically connected to the light source module and the smartphone and is used to control and power the light source module and for communication with the smartphone. The housing supports and positions the modules.

In an exemplary embodiment, the aimer includes a battery affixed to the housing and electrically connected to the electronic module. The battery is used to energize the aimer.

In another exemplary embodiment, the aimer's projection module includes a mirror.

In another exemplary embodiment, the aimer's projection module includes a lens.

In another exemplary embodiment, the aimer's electronic module includes a switch that is built into the housing. Pressing the switch causes the electronic module to activate the light source module and to signal the smartphone that the aimer has been activated.

In another exemplary embodiment, the aimer's electronic module receives power from the smartphone's battery.

In another exemplary embodiment, the aimer's housing is a formfitting case surrounding the smartphone.

In another exemplary embodiment, the aimer's light source module includes a laser.

In another exemplary embodiment, the aimer's light source module includes one or more light emitting diodes (LED)

In another aspect, the present invention embraces a case for a mobile computing device. The case includes a shell that is fit contiguously around the mobile computing device. The case supports and positions modules to help aim a camera integrated with the mobile computing device. One of the modules is a light source module for creating a light beam when activated. Another module is a projection module for forming the light beam into a pattern and projecting the pattern into an area aligned with the camera's field of view. Another module is an electronic module electrically connected to the light source module and the mobile computing device. The electronic module is configured to control and power the light source module. The electronic module is also configured to communicate with the mobile computing device.

In an exemplary embodiment, the case is for a smartphone.

In another exemplary embodiment, the case includes a battery for supplying energy. The battery is attached to the shell and is electrically connected to the electronic module.

In another exemplary embodiment, the case's electronic module is configured to receive energy from a battery in the mobile computing device.

In another exemplary embodiment, the case's electronic module includes a switch integrated with the shell. When the switch is pressed, the electronic module is triggered to activate the light source module and to signal the mobile computing device that the switch has been pressed.

In another exemplary embodiment, the case's light source module includes a laser.

In another exemplary embodiment, the case's light source module includes a light emitting diode (LED).

In another aspect, the present invention embraces a barcode scanning system. The barcode scanning system includes a smartphone with a camera for capturing images of a field of view and a processor for running a barcode scanning application for scanning barcodes. The system also includes a case that contiguously surrounds the smartphone and allows the smartphone's camera visual access to the field of view. The system further includes a light source module attached to the case for creating a light beam when activated. The system also includes a projection module attached to the case. The projection module forms the light beam into a pattern and projects the pattern in an area aligned with the camera's field of view. The system also includes an electronic module attached to the case and electrically connected to (i) the smartphone and (ii) the light source module. The electronic module is used for controlling the light source module and communicating with the smartphone.

In an exemplary embodiment, the barcode scanning system's electronic module includes a pushbutton integrated with the case. Pressing the pushbutton causes the electronic module to activate the light source module and to transmit a signal triggering the barcode scanning application to scan a barcode.

In another exemplary embodiment, the barcode scanning system's smartphone includes a battery, and the barcode scanning system's electronic module is configured to receive power from the smartphone's battery.

In another exemplary embodiment, the barcode scanning system's electronic module includes a battery for powering the light source module and the electronic module.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

Figure (FIG. 1 graphically depicts a barcode scanning system according to an embodiment of the present invention.

FIG. 2 graphically depicts and exploded view of a case for a smartphone according to an embodiment of the present invention.

FIG. 3 graphically depicts an aimer according to an embodiment of the present invention.

FIG. 4 graphically depicts a case with an integrated aimer and battery according to an embodiment of the present invention.

### DETAILED DESCRIPTION

The present invention embraces an aimer that helps a user to position and scan (i.e., read, decode, etc.) a barcode (e.g., linear barcode, matrix code, etc.) using a mobile computing device (e.g., smartphone, tablet, etc.) with an integrated imaging system (i.e., camera, illumination, processing, and software).

Users who scan barcodes regularly (e.g., as part of their daily work) need barcode scanners that respond quickly. Often these users work in environments (e.g., warehouses, delivery trucks, etc.) that make conventional imaging difficult. For example, these environments may be dark, and they may make holding a camera steady difficult. What is more, the barcodes for scanning may not always be accessible. For example, a user may have to reach around something to scan a barcode. In these cases, using the mobile computing device's imaging system for barcode scanning may be difficult.

Mobile computing devices typically have an imaging system designed for an average consumer. As a result, certain design compromises have been made. For example, the imaging subsystem (i.e., imager) must often share processing resources with other subsystems and software. As a result, imaging with a mobile computing device, while fine for the average consumer, has often been too slow and of too poor a quality to be used for serious photography and/or for the special purposes (e.g., barcode scanning). As a result, special purposed equipment (e.g., barcode scanning sleds) with specialized imaging systems have been used to enable mobile computing devices to scan barcodes.

In recent years, due in part to the economies of scale and active development, the imaging systems in mobile computing devices have improved and may now be used for barcode scanning. The problem now facing mobile computing devices used as barcode scanners concerns their ease of use.

Capturing an image of a barcode with a mobile computing device requires a user to align the barcode within a designated region on the mobile computing device's screen. Using the screen as viewfinder is often an awkward process (e.g., in low light, unfocused images, etc.). As a result, capturing a barcode image suitable for decoding often requires more than one attempt. In addition, the need for the user to focus on the screen makes barcode scanning difficult if the screen must be turned away from the user.

Enterprise-grade barcode scanners rarely use a viewfinder to align a barcode. Instead, they use an aimer, which projects a visible light pattern onto the barcode. The projected pattern corresponds to the field of view of the camera so that when the projected pattern is aligned with a barcode, an image that is suitable for barcode scanning may be captured. A user can easily point the projected pattern at a barcode, while maintaining focus on the barcode. There is a current, yet unmet need for a mobile computing device accessory (i.e., add-on) or subsystem to facilitate the same barcode-targeting scheme typically found only in enterprise-grade barcode scanners.

An exemplary embodiment of a barcode scanning system using an aimer is shown in FIG. 1. The system includes a smartphone 1. The smartphone 1 is installed into a case that has an integrated aimer to help target a barcode for scanning.

The smartphone 1 has an integrated camera for capturing images of a field of view. The integrated camera may use a lens or lens group to form a real image on a sensor. The camera's sensor may be a charge-coupled device (CCD) comprising an array of light sensitive capacitors that gather a charge resulting from incident photons. The sensor may also use an active pixel sensor array constructed using complementary metal oxide semiconductor (CMOS) technology. The sensor may capture black and white (B/W) images or may capture color images by using color filters (e.g., Bayer filter) arranged over the pixel array. The camera may use various types of electronic shutters (e.g., frame transfer, rolling shutters, etc.) to expose the sensor's pixels to light. The smartphone 1 may utilize a synchronized light source (e.g., flash) for illuminating the camera's field of view. This flash may be integrated with the smartphone or electronically attached to the smartphone as an accessory.

The smartphone includes a processor to enable the functions of the smartphone (e.g., operating system functions, input/output functions, and functions enabled by software applications). The smartphone's processor may be embodied as a system on a chip (SoC) comprising a central processing core (or cores), a graphics processor, an audio processor, and/or a video processor. The processor is configured by software applications stored in a memory (e.g., internal or external to the smartphone) to perform a variety of functions.

The processor may be configured by an application for barcode scanning. This barcode scanning application may control aspects related to targeting a barcode, imaging a barcode, processing an image, recognizing a barcode within an image, and/or decoding a barcode. The barcode scanning application may be configured to read various types of barcodes (e.g., linear barcodes, two-dimensional barcodes, color barcodes, etc.). The barcode scanning application may provide a graphical user interface (GUI) to allow a user to interact with the program (e.g., trigger a scan, read results, etc.). The barcode scanning program may store the barcode results in the smartphone's memory or may transmit the results to a host device. As a result, the barcode scanning application may also interface with other computer systems that are communicatively coupled to the smartphone (e.g., wireless computer network, cellular network, etc.).

It should be noted that while the case 5 shown in FIG. 1 may include the subsystems, modules, and/or components necessary for aiming (i.e., an aimer), the aimer might also be integrated within the smartphone's body.

The aimer includes a light source module for creating a light beam when activated (e.g., electrically powered). In some possible embodiments, the light source module may include a light emitting diode (LED) or an array of LEDs. The array of LEDs may be an array of the same LED or an array of different LEDs configured to generate different wavelengths of light. In other possible embodiments, the light source module may include a laser (e.g., laser diode). In any case, the light created by the light source module is a wavelength, or band of wavelengths, within the visible spectrum. In some embodiments, the light source module also includes a lens (or lenses) to collimate (or otherwise condense) the light radiated from the light source.

The aimer includes a projection module for forming the light beam from the light source module into an aiming pattern (i.e., pattern) and for projecting the pattern onto a target (e.g., barcode). The projection module may include a lens (or lenses), an aperture, and/or a diffractive optical element (DOE) to help form the pattern. In some embodiments, the projection module may include a mirror (or mirrors) to redirect and/or shape the light beam/pattern.

The pattern created by the aimer's projection module provides feedback regarding the camera's field of view so that when the pattern 2 is projected onto a target (e.g., a barcode 3), a user may understand what is being imaged and how that image will be aligned. To this end, the pattern may indicate the center of the camera's field of view, the edges of the camera's field of view, and/or the corners of the camera's field of view. Thus, patterns may include one or more of the following elements: a cross, a box, a line, or a corner. In a possible embodiment, the pattern may help a user to adjust the distance between the smartphone 1 and the barcoded object 4. For example, the focus of a pattern may provide information regarding the camera's ability to focus the barcode.

The aimer also includes an electronic module. The electronic module controls the power and operation of the aimer. The electronic module may include circuitry or components (e.g., microcontroller) that are communicatively coupled to the smartphone's processor and the light source module. The electronic module may also include a user input apparatus (e.g., button) to allow a user to initiate aiming and/or scanning. The electronic module may sense or otherwise receive an indication that a user has pressed the aiming button. Pressing the button may activate the light source module and may trigger a response from the mobile computing device (e.g., smartphone). For example, pressing the button may cause a smartphone to activate a barcode scanning application.

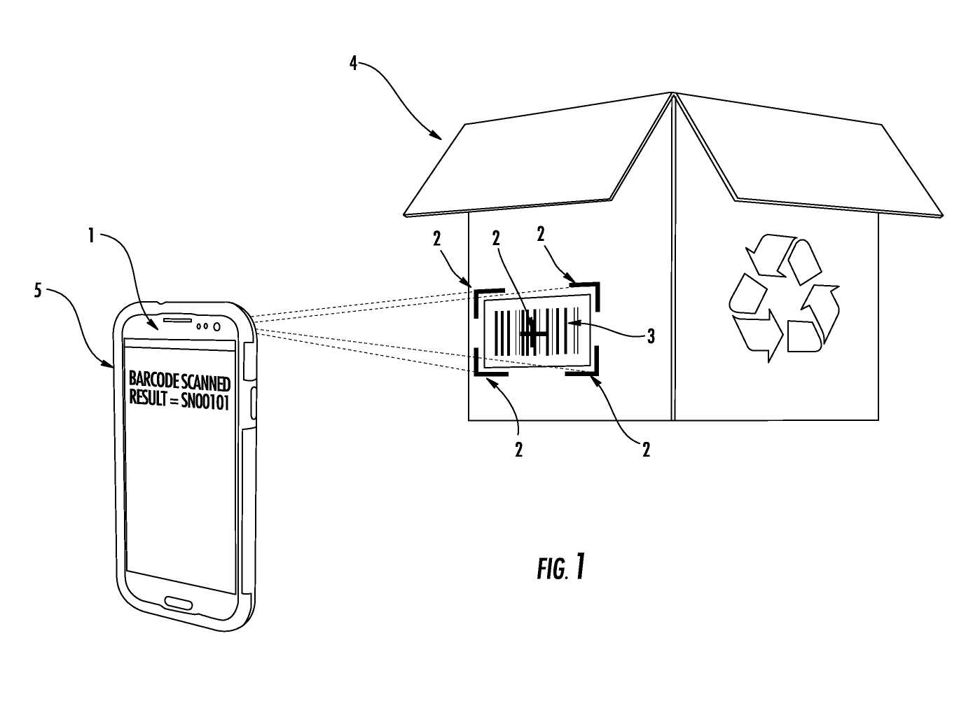

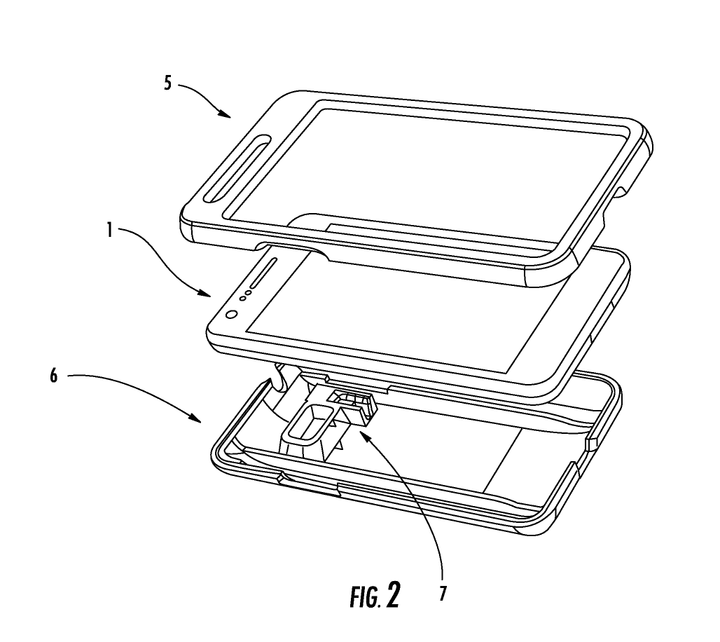

As mention previously, the aimer may be incorporated within a case for a smartphone 1. FIG. 2 graphically depicts an exploded view of an exemplary smartphone 1 and an exemplary case 5,6. Here the case 5,6 has a two-part shell. A front shell 5 and a back shell 6 (referred to collectively as the shell or housing) may be connected together (e.g., snap-fit) to contiguously surround (i.e., form fit) the smartphone 1. The case 5,6 typically supports and positions the modules for the aimer.

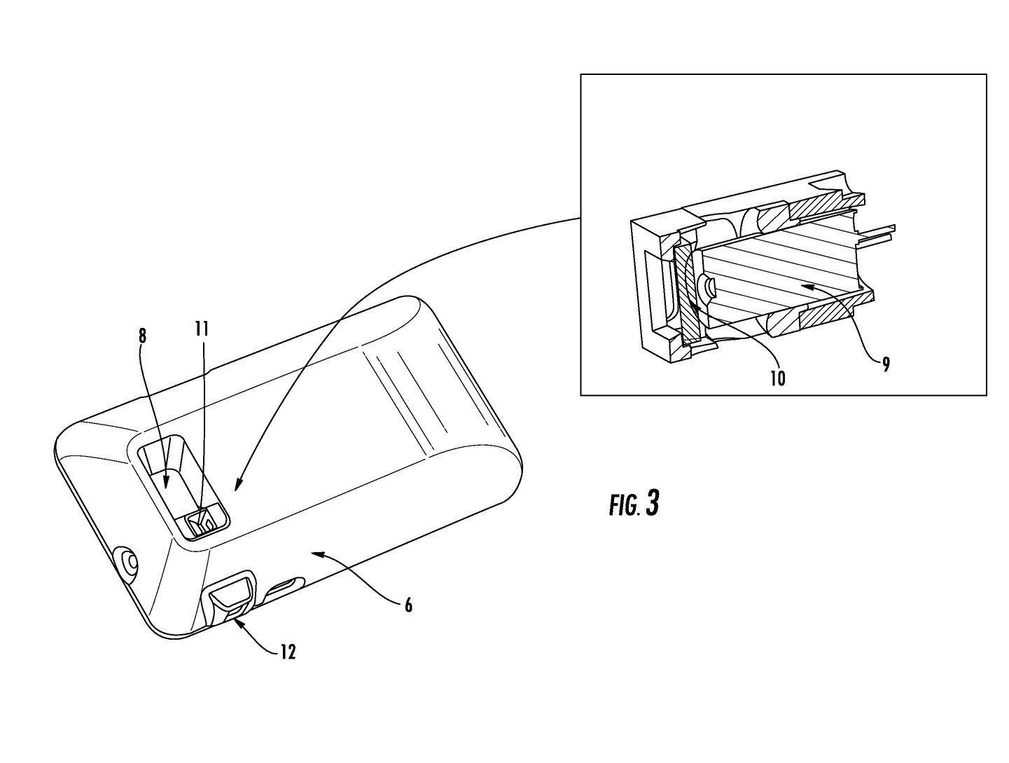

FIG. 3 graphically depicts the outer surface of the back shell 6. An aperture 8 in the back shell 6 allows the smartphone's integrated camera to have visual access to a field of view. The aimer's light source module is supported and positioned by the back shell 6 between the shell's outer surface and the smartphone body (i.e., inside the shell). The light source module is shown as an inset to FIG. 3. The exemplary light source module 9 shown includes a laser diode and a collimating lens to form a light beam. Also shown in the inset is a diffractive optical element 10 (DOE). The DOE 10 shown is used to form and project the pattern along an optical path. The optical path is redirected towards the barcode by a mirror 11.

The exemplary shell 6 (i.e., housing) also includes a switch 12 that may be pressed to initiate the aiming and/or scanning. When pressed, the switch 12 activates the aimer and may trigger the smartphone to respond. In one embodiment, the switch is connected between the light source 9 and a power source (e.g., battery). When the switch is pressed, the light source is activated by connecting the light source to the power source.

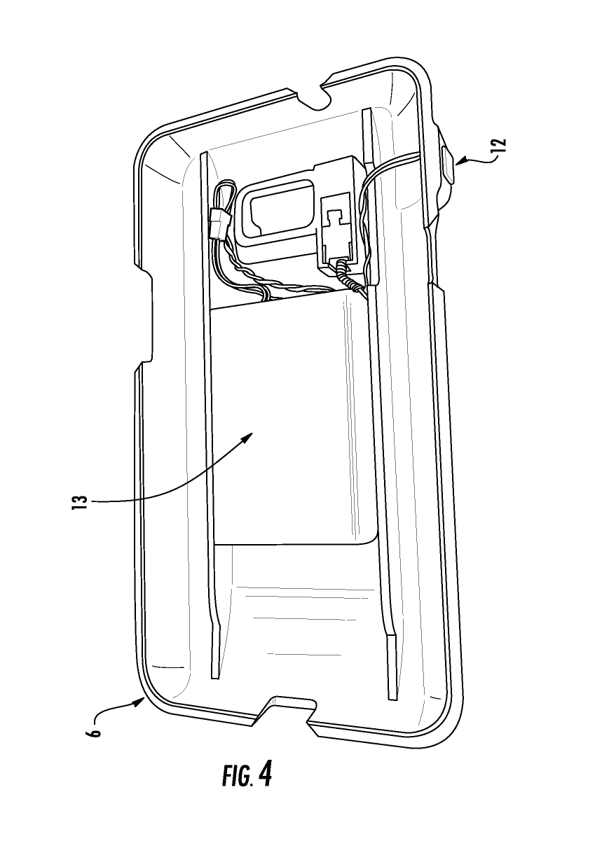

A power source is used to energize and enable the aimer. The power source may be the smartphone's battery or may be a separate battery integrated with the case (e.g., inside the case). FIG. 4 graphically depicts a case shell 6 with a battery 13 for powering the aimer according to an embodiment of the present invention.

The aimer may include an electronic module to (i) control the light source module (e.g., by connecting, conditioning, and/or distributing power from a power source) and (ii) communicate with the smartphone. For example, the electronic module may monitor the status of the switch 12. When the switch is pressed, the electronic module may activate (e.g., via switching) the light source module and may send a signal (e.g., digital signal) to the smartphone. The signal sent to the smartphone may indicate the switch has been pressed, implying that a barcode is being targeted. This signal may be used by the smartphone to initiate a barcode scan. For example, the smartphone may launch a barcode scanning program.

In another possible embodiment, the electronic module may receive signals from the smartphone 1. For example, the smartphone may transmit a signal to indicate that a barcode has been successfully scanned. This signal may cause the electronic module to deactivate, or otherwise adjust, the light source. For example, the light source may be changed (e.g., intensity/color adjusted) to provide feedback that the barcode has been scanned.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,526;
U.S. Pat. No. 8,798,367; U.S. Pat. No. 8,807,431;
U.S. Pat. No. 8,807,432; U.S. Pat. No. 8,820,630;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2011/0202554;
U.S. Patent Application Publication No. 2012/0111946;
U.S. Patent Application Publication No. 2012/0138685;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0056285;
U.S. Patent Application Publication No. 2013/0070322;
U.S. Patent Application Publication No. 2013/0075168;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0200158;
U.S. Patent Application Publication No. 2013/0256418;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0278425;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306730;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0341399;
U.S. Patent Application Publication No. 2013/0342717;
U.S. Patent Application Publication No. 2014/0001267;
U.S. Patent Application Publication No. 2014/0002828;
U.S. Patent Application Publication No. 2014/0008430;
U.S. Patent Application Publication No. 2014/0008439;
U.S. Patent Application Publication No. 2014/0025584;
U.S. Patent Application Publication No. 2014/0027518;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061305;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0075846;
U.S. Patent Application Publication No. 2014/0076974;
U.S. Patent Application Publication No. 2014/0078341;
U.S. Patent Application Publication No. 2014/0078342;
U.S. Patent Application Publication No. 2014/0078345;
U.S. Patent Application Publication No. 2014/0084068;
U.S. Patent Application Publication No. 2014/0097249;
U.S. Patent Application Publication No. 2014/0098792;
U.S. Patent Application Publication No. 2014/0100774;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0108682;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0160329;
U.S. Patent Application Publication No. 2014/0166755;
U.S. Patent Application Publication No. 2014/0166757;
U.S. Patent Application Publication No. 2014/0166759;
U.S. Patent Application Publication No. 2014/0166760;
U.S. Patent Application Publication No. 2014/0166761;
U.S. Patent Application Publication No. 2014/0168787;
U.S. Patent Application Publication No. 2014/0175165;
U.S. Patent Application Publication No. 2014/0175169;
U.S. Patent Application Publication No. 2014/0175172;
U.S. Patent Application Publication No. 2014/0175174;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0203087;
U.S. Patent Application Publication No. 2014/0204268;
U.S. Patent Application Publication No. 2014/0214631;
U.S. Patent Application Publication No. 2014/0217166;
U.S. Patent Application Publication No. 2014/0217180;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/436,337 for an Electronic Device, filed Nov. 5, 2012 (Fitch et al.);
U.S. patent application Ser. No. 13/771,508 for an Optical Redirection Adapter, filed Feb. 20, 2013 (Anderson);
U.S. patent application Ser. No. 13/852,097 for a System and Method for Capturing and Preserving Vehicle Event Data, filed Mar. 28, 2013 (Barker et al.);
U.S. patent application Ser. No. 13/902,110 for a System and Method for Display of Information Using a Vehicle-Mount Computer, filed May 24, 2013 (Hollifield);
U.S. patent application Ser. No. 13/902,144, for a System and Method for Display of Information Using a Vehicle-Mount Computer, filed May 24, 2013 (Chamberlin);
U.S. patent application Ser. No. 13/902,242 for a System For Providing A Continuous Communication Link With A Symbol Reading Device, filed May 24, 2013 (Smith et al.);
U.S. patent application Ser. No. 13/912,262 for a Method of Error Correction for 3D Imaging Device, filed Jun. 7, 2013 (Jovanovski et al.);
U.S. patent application Ser. No. 13/912,702 for a System and Method for Reading Code Symbols at Long Range Using Source Power Control, filed Jun. 7, 2013 (Xian et al.);
U.S. patent application Ser. No. 29/458,405 for an Electronic Device, filed Jun. 19, 2013 (Fitch et al.);
U.S. patent application Ser. No. 13/922,339 for a System and Method for Reading Code Symbols Using a Variable Field of View, filed Jun. 20, 2013 (Xian et al.);
U.S. patent application Ser. No. 13/927,398 for a Code Symbol Reading System Having Adaptive Autofocus, filed Jun. 26, 2013 (Todeschini);
U.S. patent application Ser. No. 13/930,913 for a Mobile Device Having an Improved User Interface for Reading Code Symbols, filed Jun. 28, 2013 (Gelay et al.);
U.S. patent application Ser. No. 29/459,620 for an Electronic Device Enclosure, filed Jul. 2, 2013 (London et al.);
U.S. patent application Ser. No. 29/459,681 for an Electronic Device Enclosure, filed Jul. 2, 2013 (Chaney et al.);
U.S. patent application Ser. No. 13/933,415 for an Electronic Device Case, filed Jul. 2, 2013 (London et al.);
U.S. patent application Ser. No. 29/459,785 for a Scanner and Charging Base, filed Jul. 3, 2013 (Fitch et al.);
U.S. patent application Ser. No. 29/459,823 for a Scanner, filed Jul. 3, 2013 (Zhou et al.);
U.S. patent application Ser. No. 13/947,296 for a System and Method for Selectively Reading Code Symbols, filed Jul. 22, 2013 (Rueblinger et al.);
U.S. patent application Ser. No. 13/950,544 for a Code Symbol Reading System Having Adjustable Object Detection, filed Jul. 25, 2013 (Jiang);
U.S. patent application Ser. No. 13/961,408 for a Method for Manufacturing Laser Scanners, filed Aug. 7, 2013 (Saber et al.);
U.S. patent application Ser. No. 14/018,729 for a Method for Operating a Laser Scanner, filed Sep. 5, 2013 (Feng et al.);
U.S. patent application Ser. No. 14/019,616 for a Device Having Light Source to Reduce Surface Pathogens, filed Sep. 6, 2013 (Todeschini);
U.S. patent application Ser. No. 14/023,762 for a Handheld Indicia Reader Having Locking Endcap, filed Sep. 11, 2013 (Gannon);
U.S. patent application Ser. No. 14/035,474 for Augmented-Reality Signature Capture, filed Sep. 24, 2013 (Todeschini);
U.S. patent application Ser. No. 29/468,118 for an Electronic Device Case, filed Sep. 26, 2013 (Oberpriller et al.);
U.S. patent application Ser. No. 14/055,234 for Dimensioning System, filed Oct. 16, 2013 (Fletcher);
U.S. patent application Ser. No. 14/053,314 for Indicia Reader, filed Oct. 14, 2013 (Huck);
U.S. patent application Ser. No. 14/065,768 for Hybrid System and Method for Reading Indicia, filed Oct. 29, 2013 (Meier et al.);
U.S. patent application Ser. No. 14/074,746 for Self-Checkout Shopping System, filed Nov. 8, 2013 (Hejl et al.);
U.S. patent application Ser. No. 14/074,787 for Method and System for Configuring Mobile Devices via NFC Technology, filed Nov. 8, 2013 (Smith et al.);
U.S. patent application Ser. No. 14/087,190 for Optimal Range Indicators for Bar Code Validation, filed Nov. 22, 2013 (Hejl);
U.S. patent application Ser. No. 14/094,087 for Method and System for Communicating Information in an Digital Signal, filed Dec. 2, 2013 (Peake et al.);
U.S. patent application Ser. No. 14/101,965 for High Dynamic-Range Indicia Reading System, filed Dec. 10, 2013 (Xian);
U.S. patent application Ser. No. 14/150,393 for Indicia-reader Having Unitary Construction Scanner, filed Jan. 8, 2014 (Colavito et al.);
U.S. patent application Ser. No. 14/154,207 for Laser Barcode Scanner, filed Jan. 14, 2014 (Hou et al.);
U.S. patent application Ser. No. 14/165,980 for System and Method for Measuring Irregular Objects with a Single Camera filed Jan. 28, 2014 (Li et al.);
U.S. patent application Ser. No. 14/166,103 for Indicia Reading Terminal Including Optical Filter filed Jan. 28, 2014 (Lu et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 14/250,923 for Reading Apparatus Having Partial Frame Operating Mode filed Apr. 11, 2014, (Deng et al.);
U.S. patent application Ser. No. 14/257,174 for Imaging Terminal Having Data Compression filed Apr. 21, 2014, (Barber et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/274,858 for Mobile Printer with Optional Battery Accessory filed May 12, 2014 (Marty et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/300,276 for METHOD AND SYSTEM FOR CONSIDERING INFORMATION ABOUT AN EXPECTED RESPONSE WHEN PERFORMING SPEECH RECOGNITION, filed Jun. 10, 2014 (Braho et al.);
U.S. patent application Ser. No. 14/305,153 for INDICIA READING SYSTEM EMPLOYING DIGITAL GAIN CONTROL filed Jun. 16, 2014 (Xian et al.);
U.S. patent application Ser. No. 14/310,226 for AUTOFOCUSING OPTICAL IMAGING DEVICE filed Jun. 20, 2014 (Koziol et al.);
U.S. patent application Ser. No. 14/327,722 for CUSTOMER FACING IMAGING SYSTEMS AND METHODS FOR OBTAINING IMAGES filed Jul. 10, 2014 (Oberpriller et al,);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/329,303 for CELL PHONE READING MODE USING IMAGE TIMER filed Jul. 11, 2014 (Coyle);
U.S. patent application Ser. No. 14/333,588 for SYMBOL READING SYSTEM WITH INTEGRATED SCALE BASE filed Jul. 17, 2014 (Barten);
U.S. patent application Ser. No. 14/334,934 for a SYSTEM AND METHOD FOR INDICIA VERIFICATION, filed Jul. 18, 2014 (Hejl);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/340,716 for an OPTICAL IMAGER AND METHOD FOR CORRELATING A MEDICATION PACKAGE WITH A PATIENT, filed Jul. 25, 2014 (Ellis);
U.S. patent application Ser. No. 14/342,544 for Imaging Based Barcode Scanner Engine with Multiple Elements Supported on a Common Printed Circuit Board filed Mar. 4, 2014 (Liu et al.);
U.S. patent application Ser. No. 14/345,735 for Optical Indicia Reading Terminal with Combined Illumination filed Mar. 19, 2014 (Ouyang);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/355,613 for Optical Indicia Reading Terminal with Color Image Sensor filed May 1, 2014 (Lu et al.);
U.S. patent application Ser. No. 14/370,237 for WEB-BASED SCAN-TASK ENABLED SYSTEM AND METHOD OF AND APPARATUS FOR DEVELOPING AND DEPLOYING THE SAME ON A CLIENT-SERVER NETWORK filed Jul. 2, 2014 (Chen et al.);
U.S. patent application Ser. No. 14/370,267 for INDUSTRIAL DESIGN FOR CONSUMER DEVICE BASED SCANNING AND MOBILITY, filed Jul. 2, 2014 (Ma et al.);
U.S. patent application Ser. No. 14/376,472, for an ENCODED INFORMATION READING TERMINAL INCLUDING HTTP SERVER, filed Aug. 4, 2014 (Lu);
U.S. patent application Ser. No. 14/379,057 for METHOD OF USING CAMERA SENSOR INTERFACE TO TRANSFER MULTIPLE CHANNELS OF SCAN DATA USING AN IMAGE FORMAT filed Aug. 15, 2014 (Wang et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/460,387 for APPARATUS FOR DISPLAYING BAR CODES FROM LIGHT EMITTING DISPLAY SURFACES filed Aug. 15, 2014 (Van Horn et al.);
U.S. patent application Ser. No. 14/460,829 for ENCODED INFORMATION READING TERMINAL WITH WIRELESS PATH SELECTON CAPABILITY, filed Aug. 15, 2014 (Wang et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/446,387 for INDICIA READING TERMINAL PROCESSING PLURALITY OF FRAMES OF IMAGE DATA RESPONSIVELY TO TRIGGER SIGNAL ACTIVATION filed Jul. 30, 2014 (Wang et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 29/486,759 for an Imaging Terminal, filed Apr. 2, 2014 (Oberpriller et al.);
U.S. patent application Ser. No. 29/492,903 for an INDICIA SCANNER, filed Jun. 4, 2014 (Zhou et al.); and
U.S. patent application Ser. No. 29/494,725 for an IN-COUNTER BARCODE SCANNER, filed Jun. 24, 2014 (Oberpriller et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. An aimer to facilitate barcode scanning using a smartphone comprising a camera, the aimer comprising:
a light source module for creating a light beam when activated;
a projection module for (i) forming the light beam into a pattern and (ii) steering and projecting the pattern into an area aligned with the smartphone camera's field of view;
an electronic module electrically connected to the light source module and the smartphone for (i) controlling and powering the light source module and (ii) communicating with the smartphone; and
a housing for supporting and positioning the light source module, the projection module, and the electronic module.

2. The aimer according to claim 1, comprising a battery affixed to the housing and electrically connected to the electronic module for energizing the aimer.

3. The aimer according to claim 1, wherein the projection module comprises a mirror.

4. The aimer according to claim 1, wherein the projection module comprises a lens.

5. The aimer according to claim 1, wherein the electronic module comprises a switch built into the housing that, when pressed, causes the electronic module to (i) activate the light source module and (ii) signal the smartphone that the aimer has been activated.

6. The aimer according to claim 1, wherein the electronic module receives power from the smartphone's battery.

7. The aimer according to claim 1, wherein the housing is a formfitting case surrounding the smartphone.

8. The aimer according to claim 1, wherein the light source module comprises a laser.

9. The aimer according to claim 1, wherein the light source module comprises one or more light emitting diodes (LED).

10. A case for a mobile computing device, comprising:
a shell fit contiguously around the mobile computing device and configured to support and position modules for aiming a camera integrated with the mobile computing device, wherein the modules comprise:
a light source module for creating a light beam when activated;
a projection module for forming the light beam into a pattern and projecting the pattern into an area aligned with the camera's field of view; and
an electronic module electrically connected to the light source module and the mobile computing device, wherein the electronic module is configured to (i) control and power the light source module and to (ii) communicate with the mobile computing device.

11. The case according to claim 10, wherein the mobile computing device is a smartphone.

12. The case according to claim 10, comprising a battery for supplying energy, the battery attached to the shell and electrically connected to the electronic module.

13. The case according to claim 10, wherein the electronic module is configured to receive energy from a battery in the mobile computing device.

14. The case according to claim 10, wherein the electronic module comprises a switch integrated with the shell that when pressed triggers the electronic module to (i) activate the light source module and (ii) signal the mobile computing device to indicate that the switch has been pressed.

15. The case according to claim 10, wherein the light source module comprises a laser.

16. The case according to claim 10, wherein the light source module comprises a light emitting diode (LED).

17. A barcode scanning system, comprising:
a smartphone comprising a camera for (i) capturing images of a field of view and (ii) a processor for running a barcode scanning application for scanning barcodes;
a case that contiguously surrounds the smartphone and allows the smartphone's camera visual access to the field of view;
a light source module attached to the case for creating a light beam when activated;
a projection module attached to the case for forming the light beam into a pattern and projecting the pattern into an area aligned with the camera's field of view; and
an electronic module attached to the case and electrically connected to the smartphone and the light source module for controlling the light source module and communicating with the smartphone.

18. The barcode scanning system according to claim 17, wherein the electronic module comprises a pushbutton integrated with the case that when pressed causes the electronic module to (i) activate the light source module and (ii) transmit a signal to the smartphone that triggers the barcode scanning application to scan a barcode.

19. The barcode scanning system according to claim 17, wherein:
the smartphone comprises a battery; and
the electronic module is configured to receive power from the smartphone's battery.

20. The barcode scanning system according to claim 17, wherein the electronic module comprises a battery for powering the light source module and the electronic module.
